(19) United States
(12) Patent Application Publication
(10) Pub. No.: US 2020/0215616 A1
(43) Pub. Date: Jul. 9, 2020

(54) Device and Method for Simultaneously Machining Several Wheelsets of a Rail Vehicle

(71) Applicant: Hegenscheidt-MFD GmbH, Erkelenz (DE)

(72) Inventors: John Oliver Naumann, Wassenberg (DE); Gregor Mingers, Übach-Palenberg (DE); Hans-Jürgen Naumann, Chemnitz (DE)

(21) Appl. No.: 16/638,592

(22) PCT Filed: Jul. 10, 2018
(86) PCT No.: PCT/EP2018/068629

§ 371 Date: Feb. 12, 2020

(30) Foreign Application Priority Data
Aug. 14, 2017 (DE) 10 2017 118 434.1

(51) Int. Cl. B23B 5/32; B24B 5/46

(52) U.S. Cl. CPC B23B 5/32; B24B 5/46

(57) ABSTRACT

What is shown and described here is a device for machining, in particular for simultaneously machining multiple wheelsets of a rail vehicle, comprising: a first underfloor wheelset lathe for reprofiling wheels and brake discs of a first wheel set of a rail vehicle, and a second underfloor wheelset lathe for reprofiling wheels and brake discs of a second wheelset of a rail vehicle. In order to allow simultaneous machining of multiple wheelsets of a rail vehicle in the installed state, it is proposed that the distance between the second underfloor wheelset lathe and the first underfloor wheelset lathe be adjustable. What is shown and described here in addition is a method for machining, in particular for simultaneously machining multiple wheelsets of a rail vehicle.

The invention concerns a device for machining, in particular for simultaneously machining several wheelsets of a rail vehicle, comprising: a first underfloor wheelset lathe for reprofiling wheels and brake discs of a first wheelset of a rail vehicle, and a second underfloor wheelset lathe for reprofiling wheels and brake discs of a second wheelset of a rail vehicle.

The invention also concerns a method of machining, in particular the simultaneous machining of multiple wheelsets of a railway vehicle, comprising the following steps: a) provision of: a first underfloor wheelset lathe for reprofiling wheels and brake discs of a first wheelset of a rail vehicle, and a second underfloor wheelset lathe for reprofiling wheels and brake discs of a second wheelset of a rail vehicle, b) provision of at least two wheelsets to be machined of a rail vehicle, c) adjusting the distance between the second underfloor wheelset lathe and the first underfloor wheelset lathe, d) depositing and clamping of the—at least—two wheelsets to be machined on the underfloor wheelset lathes associated therewith, and e) machining the—at least—two wheelsets to be machined of the rail vehicle on the underfloor wheelset lathes associated therewith.

Underfloor wheelset lathes are known from the state of the art in various embodiments, for example from DE 10 2006 007137 A1 or DE 202 14 942 U1 of the same applicant.

Underfloor wheelset lathes are usually located in a pit below a workshop track. The wheelsets to be reprofiled are brought into the machine via the workshop track in the installed condition, or by crane in the removed condition. For the reprofiling of the wheels, as well as the brake discs, the wheelsets are driven by two times two friction rollers on the running surfaces. At the same time, the wheelsets are held by fixings on their axle bearing housings. In order to achieve the highest possible machining precision while taking into account the high dynamic rigidity of the underfloor wheelset lathe, the wheelsets are centred on their axle bearing housings and guided in the direction along the axis by axial guide rollers.

With many of the known devices and methods, usually only one wheelset can be machined. This has the advantage that the alignment of the wheelset to be machined relative to the underfloor wheelset lathe is particularly simple, since the two wheel discs of the wheelset to be machined are each supported by two friction rollers, thus achieving self-centring (stable equilibrium). A very precise alignment of the wheelset to be machined is essential for a good machining result. The other unmachined wheelsets are now on the workshop track and do not need to be positioned. The individual wheelsets of a rail vehicle must therefore be machined one after the other using the known devices and methods, which increases the machining time.

In order to compensate for the disadvantage of the long machining time, it has already been suggested that the wheelsets to be machined be removed from the rail vehicle or its bogie and machined simultaneously on multiple wheelset lathes. This also has the advantage that the wheelsets to be machined are aligned quite simply relative to the wheelset lathes, since the wheelsets are decoupled from each other when removed. A disadvantage of this approach, however, is the considerable effort involved in removing and reinstalling the wheelsets.

Against this background, the invention is based on the task of designing and further developing the known and previously described devices and methods in such a way that the simultaneous machining of multiple wheelsets of a rail vehicle in the installed state is made possible.

This task is solved with a device according to the generic term of patent claim 1 by the fact that the distance between the second underfloor wheelset lathe and the first underfloor wheelset lathe is adjustable.

The invention concerns a device for machining, in particular for simultaneously machining multiple wheelsets of a rail vehicle. In particular, the device is used to machine several wheelsets of a rail vehicle simultaneously. The wheelsets should be machined in the installed state, i.e. they should not be separated from the rail vehicle during machining. The device comprises a first underfloor wheelset lathe for reprofiling wheels and brake discs from a first wheelset of a rail vehicle, and a second underfloor wheelset lathe for reprofiling wheels and brake discs from a second wheelset of a rail vehicle. The combination of two underfloor wheelset lathes is also designated as a “tandem arrangement”. For example, the first underfloor wheelset lathe and the second underfloor wheelset lathe can be used to machine two widely spaced wheelsets of a rail vehicle (e.g. “single wheelsets” of a freight car or freight wagon). In this case, the two underfloor wheelset lathes are preferably located at least 4 m, in particular at least 5 m, apart. Alternatively, the first underfloor wheelset lathe and the second underfloor wheelset lathe may be designed to machine two less widely spaced wheelsets of the same bogie of a rail vehicle (e.g. an express train or a high-speed train). In this case, the distance between the two underfloor wheelset lathes can be between 1.5 m and 3.5 m.

In accordance with the invention, it is proposed that the distance between the second underfloor wheelset lathe and the first underfloor wheelset lathe is adjustable. In particular, it may be provided for that the distance between the second underfloor wheelset lathe and the first underfloor wheelset lathe is adjustable in the direction of travel (i.e. in the longitudinal direction of the rail vehicle or in the longitudinal direction of the track). By adjusting the distance between the two underfloor wheelset lathes, adaptation to rail vehicles with different wheelbases can be achieved. In addition, the adjustability of the distance can provide for a fine adjustment that may be required if the actual distance between two wheelsets differs from the expected (nominal) distance (e.g. due to temperature variations). The distance between the two underfloor wheelset lathes can be adjusted or changed, for example, by mounting one and/or both underfloor wheelset lathes so that they can be adjusted in the direction of travel. It may be provided for that certain parts of the underfloor wheelset lathes (in particular the friction rollers intended for the support of the wheelsets) are mounted displaceably or that the entire underfloor wheelset lathes are mounted displaceably. In a configuration with two underfloor wheelset lathes, it is generally sufficient to support one of the two underfloor wheelset lathes in a displaceable manner, in which case the fixed position underfloor wheelset lathe, with fixed bearings, forms a “reference point” for the second (and possibly any additional) displaceably mounted underfloor wheelset lathe(s). An adjustability or displacement “in the direction of travel” basically also means a displacement in the opposite direction, i.e. against the direction of travel, i.e. an adjustability to both sides. The first and/or second underfloor wheelset lathes are preferably movable by at least 50 cm in the direction of travel.

A further embodiment of the device is characterized by a third underfloor wheelset lathe for reprofiling wheels and brake discs of a third wheelset of a rail vehicle, and a fourth underfloor wheelset lathe for reprofiling wheels and brake discs of a fourth wheelset of a rail vehicle. This embodiment of the device ensures that not only two, but up to four wheelsets can be machined simultaneously in their installed state. For example, two of the four underfloor wheelset lathes can each form a “pair” or “tandem”, which is assigned to the two wheelsets of a bogie. If there are two such pairs of underfloor wheelset lathes, this can be designated as a “Double Tandem” arrangement. This makes it possible to machine rail vehicles with two bogies, each with two wheelsets, in just one step.

For this embodiment it is proposed that the distance between the third underfloor wheelset lathe and the first underfloor wheel lathe is adjustable and/or that the distance between the fourth underfloor wheel lathe and the first underfloor wheel lathe is adjustable. In particular, it may be provided for that the distance between the third underfloor wheelset lathe and the first underfloor wheelset lathe is adjustable in the direction of travel (i.e. in the longitudinal direction of the rail vehicle or in the longitudinal direction of the track). In particular, it may also be provided for that the distance between the fourth underfloor wheelset lathe and the first underfloor wheelset lathe is adjustable in the direction of travel (i.e. in the longitudinal direction of the rail vehicle or in the longitudinal direction of the track). By not only adjusting the distance between the second underfloor wheelset lathe and the first underfloor wheelset lathe, but also adjusting the distance between the third underfloor wheelset lathe and/or the fourth underfloor wheelset lathe and the first underfloor wheelset lathe, adaptation to rail vehicles with different wheelbases and different bogie spacings can be achieved. The first (not necessarily, but possibly) movable underfloor wheelset lathe thus forms a “reference point” for a first wheelset to be machined. The other three underfloor wheelset lathes can then be moved in the direction of travel relative to the first underfloor wheelset lathe in order to reach the wheelsets to be machined. In this configuration of the device, the adjustability of the distance may also allow a fine adjustment, which may be required if the actual distance between two wheelsets differs from the expected (nominal) distance (e.g. due to temperature variations). The adjustment or alteration of the distances can also be achieved here, for example, by the third and/or fourth underfloor wheelset lathe being mounted so that it can be displaced in the direction of travel. It may be provided for that certain parts of the underfloor wheelset lathes (in particular the friction rollers intended for the support of the wheelsets) are mounted displaceably or that the entire underfloor wheelset lathes are mounted displaceably. The third and/or fourth underfloor wheelset lathes are preferably movable by at least 50 cm, in particular by at least 100 cm in the direction of travel.

The number of underfloor wheelset lathes is not limited to four machines, but can be increased to any number of underfloor wheelset lathes. Thus, a fifth (and additional) underfloor wheelset lathe(s) for reprofiling wheels and brake discs from a fifth wheelset (and additional wheelsets) of a rail vehicle may be provided for. If a fifth (and additional) underfloor wheelset lathe(s) is/are available, it may be provided for that the distance between the fifth (and additional) underfloor wheelset lathe(s) and the first underfloor wheelset lathe can also be adjusted. In this way, five or more wheelsets can be machined simultaneously. This even enables the simultaneous machining of the wheelsets of an entire train, i.e. the simultaneous machining of wheelsets of different cars.

In accordance with a further embodiment of the device, it is to be provided for that the first underfloor wheelset lathe and/or the second underfloor wheelset lathe and/or the third underfloor wheelset lathe and/or the fourth underfloor wheelset lathe comprises the following: a machine stand, a crossbeam for bridging a workshop track having two rails in the transverse direction, two roller carriers, four friction rollers, at least one friction roller drive for driving the friction rollers, and at least one axial guide roller for axially guiding the wheelset, wherein the crossbeam is mounted on the machine stand, with the roller carriers being movably connected to the machine stand, and with the friction rollers being rotatably mounted on the roller carrier. This type of underfloor wheelset lathe is particularly suitable for machining wheelsets and their running surfaces as well as brake discs.

According to a further embodiment of the device, it is provided for that the first underfloor wheelset lathe and the second underfloor wheelset lathe are arranged in the opposite direction and/or that a first rail support is arranged between these two underfloor wheelset lathes. An opposite arrangement can be understood in particular as an arrangement with a plane of symmetry (mirror symmetry). The two underfloor wheelset lathes are thus “back to back”. This arrangement has the advantage, for example, that the two underfloor wheelset lathes can be arranged particularly close to each other and can therefore also machine wheelsets with a small wheelbase (for example, two wheelsets of the same bogie). The close arrangement can be achieved by assigning those sides of the underfloor wheelset lathes with less extensively protruding parts to each other, while those sides with more extensively protruding parts (e.g. access stairs) are arranged facing away from each other. The rail support arranged between the two underfloor wheelset lathes serves the purpose of supporting the slide rails running there, as these rails would otherwise have to bridge the pit recessed in the workshop floor without any support. As an alternative, it may be provided for here that the first underfloor wheelset lathe and the second underfloor wheelset lathe may be arranged in the same direction, for example on two “single machines” far apart from one another.

With regard to the first rail support, it is further proposed that the first rail support be displaceable relative to the first underfloor wheelset lathe and/or relative to the second underfloor wheelset lathe. By moving the rail support in the direction of travel, the position of the rail support can be adjusted to the positions of the underfloor wheelset lathes, which are also displaceable. In particular, in the case of a displaceable rail support, the underfloor wheelset lathes can be moved over longer distances without colliding with the rail support.

A further embodiment of the device provides that the third underfloor wheelset lathe and the fourth underfloor wheelset lathe are arranged in opposite directions and/or that a second rail support is arranged between these two underfloor wheelset lathes. The characteristics and advantages of this embodiment have already been described in more detail in connection with the first and second underfloor wheelset lathe. The mirror-symmetrical arrangement permits a particularly close arrangement of the two underfloor wheelset lathes. Here, too, the movable support of the rail support serves the purpose of being able to assume the optimum position relative to the—likewise movable—underfloor wheelset lathes and to avoid collisions with the same.

With regard to the second rail support, it is also proposed that the second rail support be movable relative to the third underfloor wheelset lathe and/or relative to the fourth underfloor wheelset lathe. The characteristics and advantages of this embodiment have also been described already in more detail in connection with the first rail support. If the configuration of the vehicle to be processes permits it, it may be possible to dispense with the displaceability the first rail support. The second rail support should, however, be movable in the direction of travel, as the third and fourth underfloor wheelset lathes often have to be moved over longer distances. This is because the bogie spacings between different rail vehicles often differ by more than the differences between the wheelbases within the different bogies.

With regard to the second rail support, it may alternatively be provided for that the second rail support is mechanically coupled to the third underfloor wheelset lathe or the fourth underfloor wheelset lathe. The mechanical connection links the movement of the second rail support with the movement of one of the underfloor wheelset lathes; independent movement is therefore no longer possible. One advantage of the mechanical coupling is that the control of the device is less complex, since the second rail support is automatically moved with one of the adjacent underfloor wheelset lathes.

Finally, a further embodiment of the device is characterised by a device for controlling the positioning of the underfloor wheelset lathes and/or the rail supports. By providing a device, in particular an electronic device, an automatic control of the underfloor wheelset lathes and/or the rail supports can be achieved. For example, stored, vehicle-specific data can be used, so that automatic (pre-)positioning of the underfloor wheelset lathes and/or rail supports takes place after the vehicle type has been entered. This is faster and less error-prone compared to manual positioning.

The task described above is also solved by a method for machining, in particular for simultaneous machining of several wheelsets of a rail vehicle. The method comprises the following steps: a) provision of: a first underfloor wheelset lathe for reprofiling wheels and brake discs of a first wheelset of a rail vehicle, and a second underfloor wheelset lathe for reprofiling wheels and brake discs of a second wheelset of a rail vehicle, b) provision of at least two wheelsets to be machined of a rail vehicle, c) adjusting the distance between the second underfloor wheelset lathe and the first underfloor wheelset lathe, d) depositing and clamping of the—at least—two wheelsets to be machined on the underfloor wheelset lathes associated therewith, and e) machining the—at least—two wheelsets to be machined of the rail vehicle on the underfloor wheelset lathes associated therewith.

The adjustment of the distance between the underfloor wheelset lathes in the direction of travel provided for in step c) allows adaptation to different rail vehicles. In this way, multiple wheelsets—independent of their distances to one another—can be machined simultaneously. This shortens the machining time considerably.

An embodiment of the method is characterized in that in step a) additionally a third underfloor wheelset lathe for reprofiling wheels and brake discs of a third wheelset of a rail vehicle and a fourth underfloor wheelset lathe for reprofiling wheels and brake discs of a fourth wheelset of a rail vehicle are provided, in that in step b) four rail vehicle wheelsets to be machined are provided, in that, in step c), the distance between the third underfloor wheelset lathe and the first underfloor wheelset lathe is additionally adjusted, and in that the distance between the fourth underfloor wheelset lathe and the first underfloor wheelset lathe is adjusted, in that in step d) four wheelsets to be machined are set down and clamped on the underfloor wheelset lathes assigned to them, and in that in step e) additionally the third wheelset and/or the fourth wheelset of the rail vehicle is/are machined on the underfloor wheelset lathes assigned to them. This embodiment of the method ensures that not only two, but up to four wheelsets can be machined simultaneously in their installed state. For example, two of the four underfloor wheelset lathes can each form a “pair” or “tandem”, which is assigned to the two wheelsets of a bogie. If there are two such pairs of underfloor wheelset lathes, this can be designated as a “Double Tandem” arrangement.

In accordance with a further embodiment of the method, it is envisaged that in step a) an underfloor wheelset lathe will be provided in accordance with one of the patent claims 1 to 10. The underfloor wheelset lathe described above is particularly suitable for carrying out the method due to the properties and advantages mentioned in all the embodiments described.

A further embodiment of the method provides that step c) comprises the following sub-steps: ca) determining the type of rail vehicle with the wheelsets to be machined, and cb) setting of stored, vehicle-specific distances between the second and/or third and/or fourth underfloor wheelset lathe(s) and the first underfloor wheelset lathe. By defining and entering the next vehicle type to be processed, presetting or pre-positioning of the underfloor wheelset lathes can be achieved. The first underfloor wheelset lathe does not need to change its position, as this underfloor wheelset lathe is regarded as an orientation point and the rail vehicle moves so far forward that the wheelset to be machined by the first underfloor wheelset lathe is arranged exactly above this underfloor wheelset lathe. Depending on the vehicle type, however, the other underfloor wheelset lathes have to change their position in order to reach the wheelsets to be machined by them. This position change is advantageously effected by stored, vehicle-specific specifications, which are corrected slightly if necessary.

This embodiment of the method can be supplemented by the following step, which is carried out after step ca) and before, simultaneously with or after step cb): cc) Setting a stored, vehicle-specific position of at least one rail bridge. By means of this step, a presetting or pre-positioning of the rail bridge can be achieved. This can be done before, simultaneously with or after the presetting or pre-positioning of the underfloor wheelset lathes. Simultaneous presetting or pre-positioning can be achieved, for example, by mechanically coupling the rail bridge to one of the underfloor wheelset lathes.

In accordance with a further embodiment of the method, it is proposed that step d) comprises the following partial steps: da) setting down and clamping the first wheelset to be machined on the underfloor wheelset lathe assigned to the same, db) measuring the actual distances between the rail vehicle wheelsets to be machined, dc) adapting the preset distances between the second and/or third and/or fourth underfloor wheelset lathe(s) and the first underfloor wheelset lathe to the actually measured distances between the rail vehicle wheelsets to be machined, and dd) setting down and clamping the second, third and fourth wheelsets to be machined on the underfloor wheelset lathes associated therewith. This embodiment concerns the step-by-step setting down and clamping of the wheelsets. The setting down and clamping of the first wheelset is rather unproblematic, since this wheelset is set down and clamped first, so that no consideration needs to be given to the position of the other wheelsets. Before setting down and clamping the other wheelsets, however, it is advisable to check whether the preset positions of the underfloor wheelset lathes assigned to them are correct or whether these positions must be slightly corrected and adapted. For this purpose, a measurement of the actual distances between the rail vehicle wheelsets to be machined is proposed. If the measured distances deviate from the preset distances, the preset distances are adjusted to the actual conditions before the other wheelsets can be set down and clamped.

The method can finally be supplemented by the following step, which is carried out before step d): cz) Retraction of the slide rails. After the friction rollers of the underfloor wheelset lathes have lifted the wheelsets, the slide rails can be retracted. The slide rails are preferably embodied in two parts, so that both parts can be retracted and extended independently of each other. The retraction of the slide rails is also referred to as the opening of the slide rails.

The invention will be explained in more detail below using a drawing representing only one preferred design example. In the drawing the following items are shown:

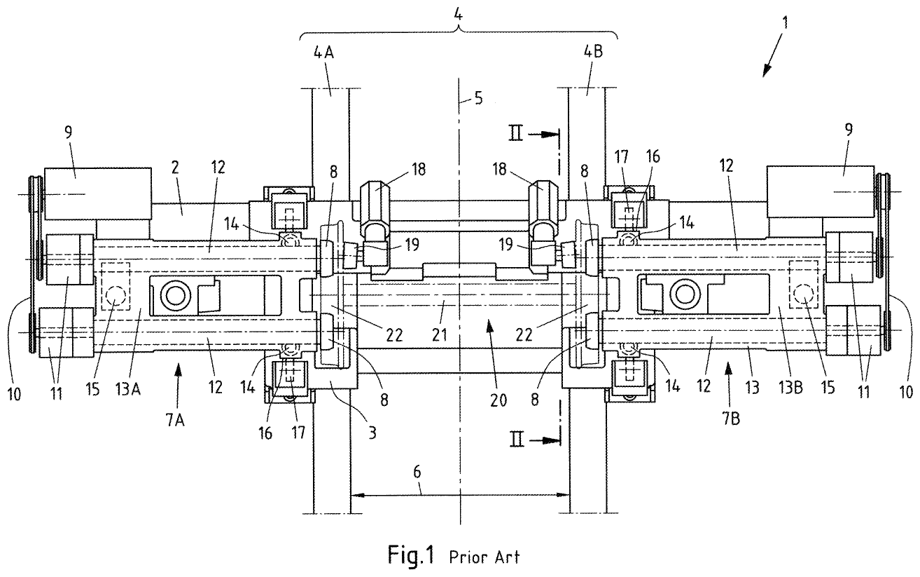

FIG. 1: an underfloor wheelset lathe known from the state of the art in a plan view,

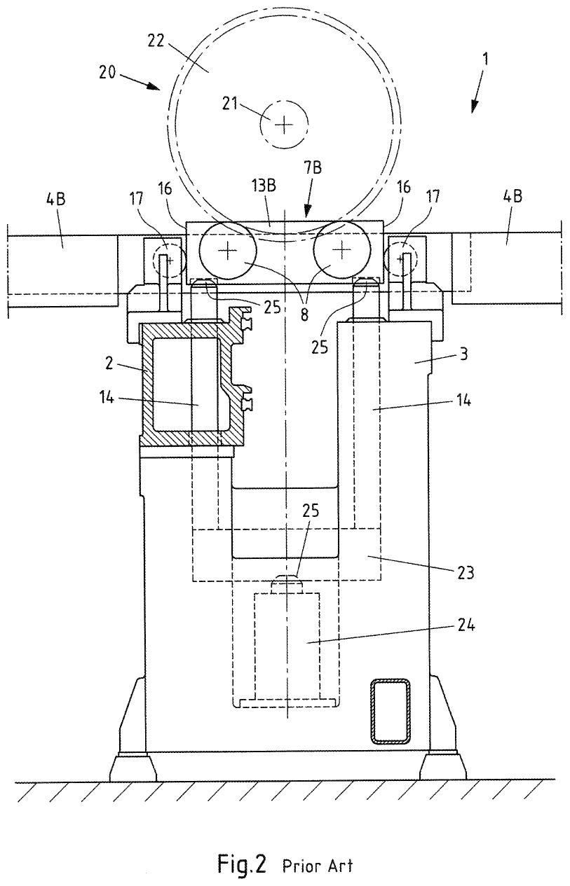

FIG. 2: the underfloor wheelset lathe from FIG. 1 in a cut view along the cutting plane II-II as drawn in FIG. 1,

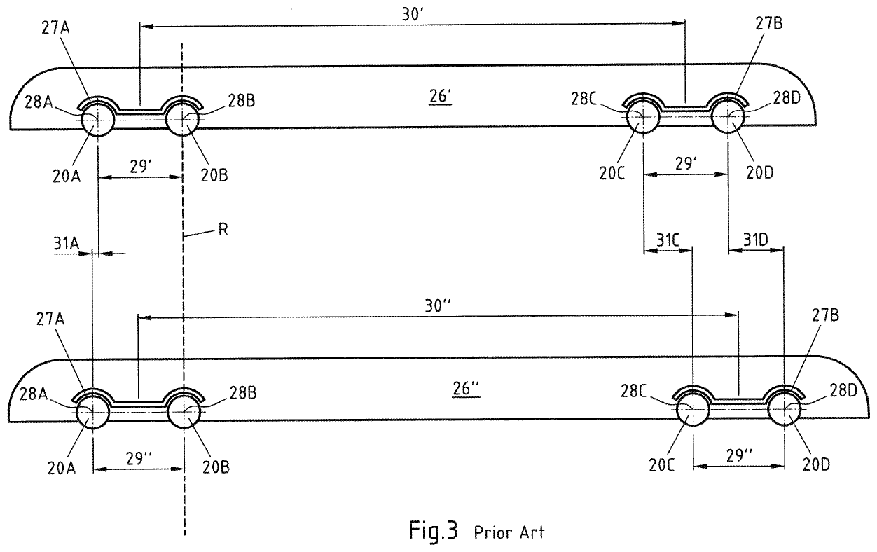

FIG. 3: a first embodiment and a second embodiment of a state of the art rail vehicle in a side view,

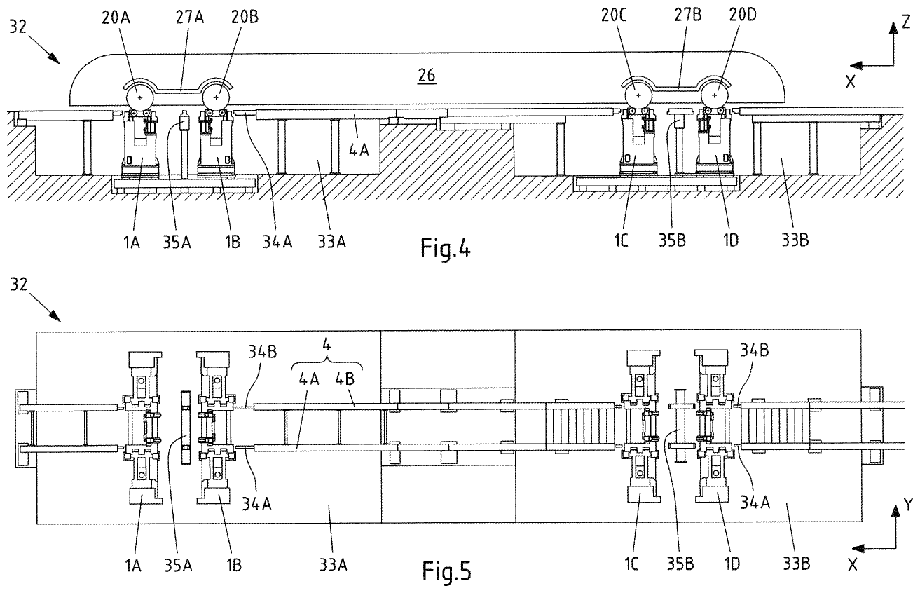

FIG. 4: a device in accordance with the invention in a side view,

FIG. 5: the device from FIG. 4 in a plan view,

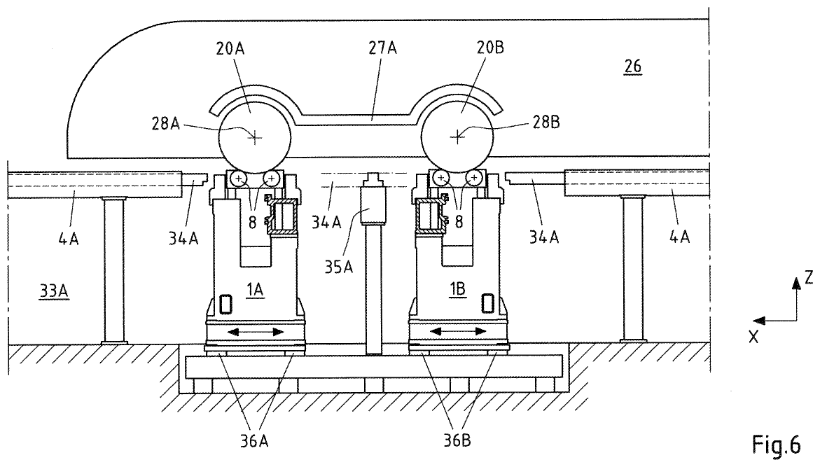

FIG. 6: a first sub-area of the device from FIG. 4 in an enlarged side view,

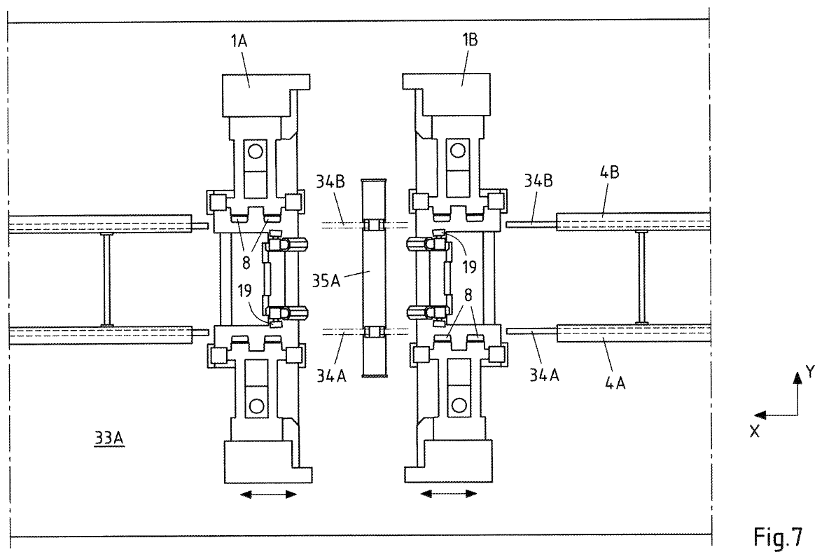

FIG. 7: the first sub-area from FIG. 6 in a plan view,

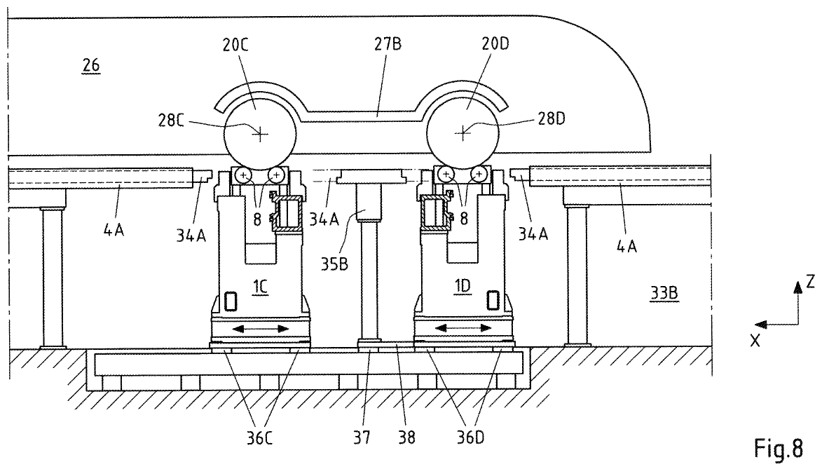

FIG. 8: a second sub-area of the device from FIG. 4 in an enlarged side view,

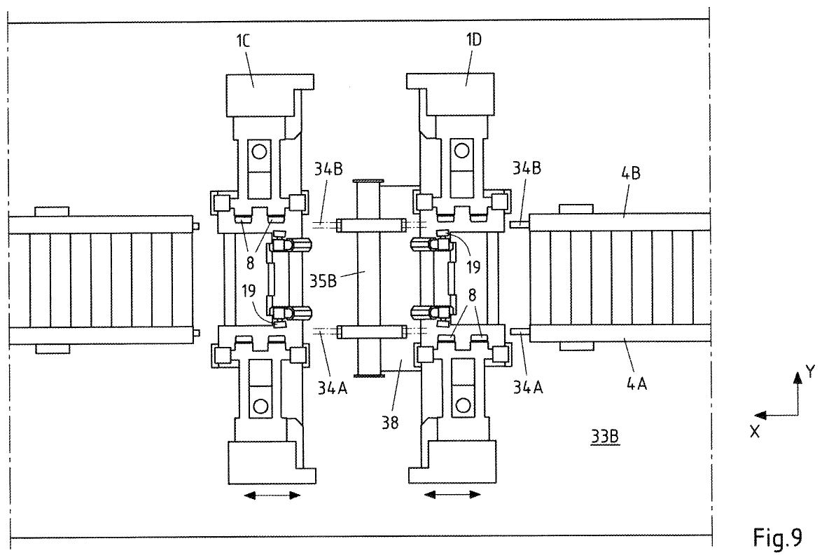

FIG. 9: the second sub-area from FIG. 7 in a plan view, and

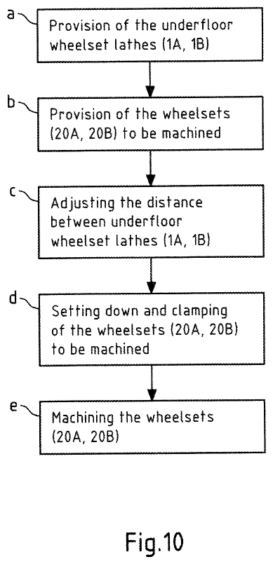

FIG. 10: the sequence of the method in accordance with the invention in a schematic representation.

FIG. 1 shows an underfloor wheelset lathe 1, known from the state of the art, in a plan view. The underfloor wheelset lathe 1 shown has a crossbeam 2 which is mounted on a machine stand 3 (largely concealed in FIG. 1). The machine stand 3 can be placed on a workshop floor and is therefore stationary and cannot be moved. In addition, a track 4 is shown which consists of two rails 4A, 4B running in parallel to one another and include a central axis 5. The distance between the inner edges of the two rails 4A, 4B is designated as track gauge 6. The crossbeam 2 runs approximately at a right angle to the two rails 4A, 4B and to their central axis 5. The underfloor wheelset lathe 1 has two roller carriers 7A, 7B which are arranged at opposite ends of the machine stand 3. Two friction rollers 8 are rotatably mounted on each of the two roller carriers 7A, 7B. The friction rollers 8 are driven by a friction roller drive 9, which transmits its drive power to the two friction rollers 8 via a belt drive 10, two gears 11 and two shafts 12. Instead of the belt drive 10, other means of load transmission could also be used. The roller carriers 7A, 7B each have a housing 13A, 13B in which the shafts 12 are rotatably mounted.

The two roller carriers 7A, 7B are supported vertically at three points, namely on two vertical rods 14 (inside) and one bracket 15 (outside). Alternatively, other embodiments of the roller carriers 7A, 7B are also possible. The two roller carriers 7A, 7B each have two guide surfaces 16, which can roll on rollers 17, which are provided on the crossbeam 2 or on the machine stand 3. The support of the roller carriers 7A, 7B is explained in more detail in connection with FIG. 2. The underfloor wheelset lathe 1 shown in FIG. 1 also has two holders 18, on each of which an axial guide roller 19 is rotatably mounted. On the underfloor wheelset lathe 1 shown in FIG. 1, a wheelset 20 can be machined, which in the example case shown comprises a wheelset shaft 21 and two wheel discs 22. The wheelset 20 may also include brake discs which are not shown in FIG. 1 for better clarity.

FIG. 2 shows the underfloor wheelset lathe 1 from FIG. 1 in a cut view along the cutting plane II-II as drawn in FIG. 1. Those areas of the underfloor wheelset lathe 1 which have already been described in connection with FIG. 1 are provided with corresponding reference numbers in FIG. 2—and in all other figures. In the cut view, the roughly rectangular cross-section of the crossbeam 2 is clearly visible. In addition, the view selected in FIG. 2 clearly shows that the wheel discs 22 of the wheelset 20 are supported by the two friction rollers 8 and that the rotation of the friction rollers 8 also causes the wheel discs 22 to rotate. The support of the housing 13B of the roller carrier 7B on the two vertical rods 14 is also clearly visible. The two vertical rods 14 are connected in their lower part by a fork 23. The fork 23 can be moved vertically, i.e. raised and lowered, by a lifting cylinder 24 connected to the machine stand 3. This vertical movement also moves the roller carrier 7B and the friction rollers 8 mounted on it in the vertical direction, which allows the underfloor wheelset lathe 1 to be adapted to wheel discs 22 with different diameters. The connection between the housing 13B of the roller carrier 7B and the vertical rods 14 is made via suitable joints 25, as is the connection between fork 23 and lifting cylinder 24. The principle of positioning the roller carrier 7B in the direction of the rail 4B can also be seen: The roller carrier 7B has two guide surfaces 16, which can roll on rollers 17, which are provided on the crossbeam 2 or the machine stand 3. In order to place the wheelset 20 on the friction rollers 8, the rail 4B (as well as the rail 4A not shown) is interrupted 5 in the area of the friction rollers 8 and can be telescopically extended and retracted there.

FIG. 3 shows a first embodiment and a second embodiment of a state of the art rail vehicle 26 in a side view. The first embodiment of the rail vehicle 26′ is shown at the top of FIG. 3, and the second embodiment of the rail vehicle 26″ is shown at the bottom of FIG. 3. Both rail vehicles 26′, 26″ each have two bogies 27A, 27B, in the frames of which two wheelsets 20A, 20B, 20C, 20D are rotatably mounted. Each wheelset 20A, 20B, 20C, 20D has a centrally located axis of rotation 28A, 28B, 28C, 28D. The two wheelsets 20 of each bogie 27 have a distance from each other in the longitudinal direction (i.e. in the direction of travel) of the rail vehicle 26, which is referred to as wheelbase 29. In addition, both bogies 27 of the rail vehicle 26 have a distance to each other in the longitudinal direction, which is referred to as the bogie distance 30. The first embodiment of the rail vehicle 26′ and the second embodiment of the rail vehicle 26″ have wheelbases 29′, 29″ and bogie spacings 30′, 30″, respectively of different sizes. In order to illustrate the differences, a reference plane R is shown in FIG. 3, which runs through the axes of rotation 28B of the two second wheelsets 20B, each seen from the left. Alternatively, the reference plane R could also run through the axis of rotation of another wheelset. In the left area of FIG. 3 it can be seen that the wheelbase 29″ of the lower rail vehicle 26″ is slightly larger than the wheelbase 29′ of the upper rail vehicle 26′; thus there is a length difference 31A on the first two wheelsets 20A. Since the bogie spacing 30″ of the lower rail vehicle 26″ is also greater than the bogie spacing 30′ of the upper rail vehicle 26′, there is also a length difference 31C on the two third wheelsets 20C; there is also a length difference 31D on the two fourth wheelsets 20D which corresponds to the sum of the length difference 31A and the length difference 31C. The bogie spacings 30′, 30″ are usually more than 10 m; they can range between 16.0 m and 20.0 m, for example. The wheelbases 29′, 29″, on the other hand, are usually considerably shorter than 5 m; they can be in the range between 1.5 m and 3.5 m, for example.

The different dimensions of the two rail vehicles 26′, 26″ shown in FIG. 3 make the machining of wheelsets 20A, 20B, 20C, 20D more difficult when changing the vehicle type (e.g. from 26′ to 26″). In particular, the wheelsets 20A, 20B, 20C, 20D have different positions depending on the vehicle type due to the length differences 31A, 31C, 31D, so that the tools used to machine the corresponding wheelsets 20A, 20B, 20C, 20D must also be positioned accordingly. In addition, especially with larger lengths—for example with bogie spacings of 30′, 30″—there are minor thermal length changes in the range of a few millimetres, which must also be compensated to ensure a precise machining result. This is achieved by the device described below and the method described below.

FIG. 4 shows a device 32 in accordance with the invention in a side view. FIG. 5 shows the device 32 from FIG. 4 in a plan view. The device 32 shown in FIG. 4 and in FIG. 5 is used to machine multiple wheelsets 20 of a rail vehicle 26. In particular, the device 32 shown serves to machine several—in particular all—wheelsets 20 of the same rail vehicle 26 at the same time. The rail vehicle 26 may, for example, be one of the two rail vehicles 26′, 26″ described above in connection with FIG. 3. The device 32 shown and preferred in FIG. 4 comprises a total of four underfloor wheelset lathes 1A, 1B, 1C, 1D for the reprofiling of wheels and brake discs of the four wheelsets 20A, 20B, 20C, 20D of the rail vehicle 26. Each of the four wheelsets 20A, 20B, 20C, 20D to be machined is therefore assigned its own underfloor wheelset lathe 1A, 1B, 1C, 1D. The underfloor wheelset lathes 1A, 1B, 1C, 1D, for example, are the underfloor wheelset lathe 1 already described in connection with FIG. 1 and FIG. 2.

The two underfloor wheelset lathes 1A, 1B shown on the left in FIG. 4 and FIG. 5 are arranged in a first pit 33A and are used for machining the two wheelsets 20A, 20B mounted in the first bogie 27A. The two underfloor wheelset lathes 1C, 1D shown on the right are arranged in a second pit 33B and serve to machine the two wheelsets 20C, 20D mounted in the second bogie 27B. Thus, all four wheelsets 20A, 20B, 20C, 20D can be machined simultaneously by the device 32. The arrangement of the four underfloor wheelset lathes 1A-1D in two pits 33A, 33B serves the purpose that the underfloor wheelset lathes 1A-1D are arranged below the height of a track 4, laid on the ground, with two rails 4A, 4B. The two rails 4A, 4B are interrupted in the area of the two underfloor wheelset lathes 1A, 1B arranged in the first pit 33A as well as in the area of the two underfloor wheelset lathes 1C, 1D arranged in the second pit 33B, and are replaced there by movable slide rails 34A, 34B. The two slide rails 34A, 34B can be extended (when moving rail vehicle 26 in and out) and retracted (when machining the wheelsets 20A-20D). To support the two slide rails 34A, 34B, a rail support 35A, 35B is provided both between the two underfloor wheelset lathes 1A, 1B arranged in the first pit 33A and between the two underfloor wheelset lathes 1C, 1D arranged in the second pit 33B. With the device 32 shown in FIG. 4 and FIG. 5, the slide rails 34A, 34B are embodied in two parts, so they can be extended and retracted in opposite directions and “meet” on the rail supports 35A, 35B when extended. Alternatively, single-part slide rails would also be possible. In order to be able to adapt the positions of the four 1A-1D underfloor wheelset lathes to different rail vehicles 26, some or all 1A-1D underfloor wheelset lathes can be moved in the direction of travel X (i.e. in the longitudinal direction of the rail vehicle 26 or in the longitudinal direction of track 4). This property of the device 32 is described in more detail below.

FIG. 6 shows a first sub-area of the device 32 from FIG. 4 in an enlarged side view. In FIG. 7 the first sub-area from FIG. 6 is shown in a plan view. The sub-area shown is the area shown in FIG. 4 on the left. Those areas of device 32 which have already been described in connection with device 32 in FIG. 4 and FIG. 5 are provided with corresponding reference numbers in FIG. 6 and FIG. 7. In FIG. 6 and FIG. 7 it can be seen that the device 32 is shown in its working position. This can be seen from the fact that the two-piece slide rails 34A, 34B are retracted so that the wheel discs 22 of the two wheelsets 20A, 20B are no longer supported on the slide rails 34A, 34B but on the friction rollers 8 of the respective underfloor wheelset lathe 1A, 1B. In order to be able to machine the wheelsets 20A, 20B of rail vehicles 26 with different wheel bases 29, it is provided in the case of device 32 that the distance in the direction of travel (X coordinate of the coordinate system shown) can be adjusted between the second underfloor wheelset lathe 1B and the first underfloor wheelset lathe 1A. This can be achieved, for example, by the fact that the first underfloor wheelset lathe 1A and/or the second underfloor wheelset lathe 1B has a support 36A, 36B which permits a displacement of the underfloor wheelset lathe 1A, 1B in the direction of travel (X coordinate of the coordinate system represented) (shown by double arrows). The rail support 35A shown in FIG. 6 and FIG. 7, on the other hand, cannot be moved and is therefore stationary.

FIG. 8 shows a second sub-area of the device 32 from FIG. 4 in an enlarged side view. In FIG. 9 the second sub-area from FIG. 7 is shown in a plan view. The sub-area shown is the area shown in FIG. 4 on the right. Those areas of device 32 which have already been described in connection with device 32 in FIG. 4 to FIG. 7 are provided with corresponding reference numbers in FIG. 8 and FIG. 9. In FIG. 8 and FIG. 9 it can be seen that the device 32 is shown in its working position. This can be seen from the fact that the two-piece slide rails 34A, 34B are retracted so that the wheel discs 22 of the two wheelsets 20C, 20D are no longer supported on the slide rails 34A, 34B but on the friction rollers 8 of the respective underfloor wheelset lathe 1C, 1D. In order to be able to machine the wheelsets 20C, 20D of rail vehicles 26 with different wheel bases 29, it is provided in the case of device 32 that the distance in the direction of travel (X coordinate of the coordinate system shown) can be adjusted between the fourth underfloor wheelset lathe 1D and the third underfloor wheelset lathe 1C. This can be achieved, for example, by the fact that the third underfloor wheelset lathe 1C and/or the fourth underfloor wheelset lathe 1D has a support 36C, 36D which permits a displacement of the underfloor wheelset lathe 1C, 1D in the direction of travel (X coordinate of the coordinate system represented) (shown by double arrows). The rail support 35B shown in FIG. 7 and FIG. 8 also has a support 37; it is also mechanically coupled to the fourth underfloor wheelset lathe 1D via a coupling element 38. A displacement of the fourth underfloor wheelset lathe 1D therefore results in a corresponding displacement of the rail support 35B. Alternatively, the rail support 35B can also be decoupled from the fourth underfloor wheelset lathe 1D (and all other underfloor wheelset lathes), so that the rail support 35B can be moved in the direction of travel (X coordinate of the coordinate system shown) independently of the underfloor wheelset lathes 1A-1D.

With the device 32 shown in FIG. 4 to FIG. 9, all four underfloor wheelset lathes 1A-1D are mounted on supports 36A, 36B, 35C, 36D in the direction of travel X such that they can be displaced. In order to realize the idea in accordance with the invention, one of the four underfloor wheelset lathes 1A could also be immovably mounted, provided that the other (here: three) underfloor wheelset lathes 1B, 1C, 1D are displaceably mounted in the direction of travel X and can move relative to the immovably mounted underfloor wheelset lathe 1A. Which of the four underfloor wheelset lathes 1A, 1B, 1C, 1D is immovably mounted is irrelevant if all other underfloor wheelset lathes 1A, 1B, 1C, 1D are displaceably or movably mounted.

Finally, FIG. 10 shows the sequence of the method in accordance with the invention in a schematic representation. The method comprises the following steps: a) provision of: a first underfloor wheelset lathe for reprofiling wheels and brake discs of a first wheelset of a rail vehicle, and a second underfloor wheelset lathe for reprofiling wheels and brake discs of a second wheelset of a rail vehicle, b) provision of at least two wheelsets to be machined of a rail vehicle, c) adjusting the distance between the second underfloor wheelset lathe and the first underfloor wheelset lathe, d) depositing and clamping of the—at least—two wheelsets to be machined on the underfloor wheelset lathes associated therewith, and e) machining the—at least—two wheelsets to be machined of the rail vehicle on the underfloor wheelset lathes associated therewith.

### LIST OF REFERENCE NUMBERS

1, 1A, 1B, 1C, 1D: Underfloor wheelset lathe
2: Crossbeam
3: Machine stand
4: Track
4A, 4B: Rail
5: Central axis
6: Track gauge
7A, 7B: Roller carrier
8: Friction roller
9: Friction roller drive
10: Belt drive
11: Gear unit
12: Shaft
13A, 13B: Housing (of the roller carrier 7A, 7B)
14: Vertical rod
15: Bracket
16 Guide surface
17: Roller
18: Holder
19: Axial guide roller
20, 20A, 20B, 20C, 20D: Wheelset
21: Wheelset shaft
22: Wheel disc
23: Fork
24: Lifting cylinder
25: Joint
26, 26′, 26″: Rail vehicle
27A, 27B: Bogie
28A, 28B, 28C, 28D: Axis of rotation (of a wheelset 20)
29, 29′, 29″: Wheelbase
30, 30′, 30″: Bogie spacing
31A, 31C, 31D: Wheelbase difference
32: Device (for machining multiple wheelsets)
33A, 33B: Pit
34A, 34B: Slide rail
35A, 35B: Rail support
36A, 36B: Support (of the underfloor wheelset lathe)
37: Support (of the rail support)
38: Coupling element
R: Reference level
X: Longitudinal direction/Direction of travel
Y: Transverse direction

1-17. (canceled)

18. A device for machining, in particular for simultaneously machining multiple wheelsets of a rail vehicle, comprising:
a first underfloor wheelset lathe for reprofiling wheels and brake discs from a first wheelset of a rail vehicle,
a second underfloor wheelset lathe for reprofiling wheels and brake discs from a second wheelset of a rail vehicle,
a third underfloor wheelset lathe for reprofiling wheels and brake discs from a third wheelset of a rail vehicle, and
a fourth underfloor wheelset lathe for reprofiling wheels and brake discs from a fourth wheelset of a rail vehicle,
wherein a second rail support is arranged between the third underfloor wheelset lathe and the fourth underfloor wheelset lathe,
wherein the distance between the second underfloor wheelset lathe and the first underfloor wheelset lathe is adjustable,
wherein the distance between the third underfloor wheelset lathe and the first underfloor wheelset lathe is adjustable, and/or
wherein the distance between the fourth underfloor wheelset lathe and the first underfloor wheelset lathe is adjustable,
characterised in that
the second rail support is displaceable relative to the third underfloor wheelset lathe and/or relative to the fourth underfloor wheelset lathe.

19. The device according to claim 18,
characterised in that
the first underfloor wheelset lathe and/or the second underfloor wheelset lathe and/or the third underfloor wheelset lathe and/or the fourth underfloor wheelset lathe comprise(s) the following:
a machine stand,
a crossbeam for bridging a workshop track with two rails in the transverse direction,
two roller carriers,
four friction rollers,
at least one friction roller drive for driving the friction rollers, and
at least one axial guide roller for axial guidance of the wheelset,
with the crossbeam being mounted on the machine stand,
with the roller carriers being movably connected to the machine stand, and
with the friction rollers being rotatably mounted on the roller carrier.

20. The device according to claim 18,
characterised in that
the first underfloor wheelset lathe and the second underfloor wheelset lathe are arranged in opposite directions and/or in that a first rail support is arranged between these two underfloor wheelset lathes.

21. The device according to claim 20,
characterised in that
the first rail support is displaceable relative to the first underfloor wheelset lathe and/or relative to the second underfloor wheelset lathe.

22. The device according to claim 18,
characterised in that
the third underfloor wheelset lathe and the fourth underfloor wheelset lathe are arranged in opposite directions.

23. The device according to claim 18,
characterised in that
the second rail support is mechanically coupled to the third underfloor wheelset lathe or to the fourth underfloor wheelset lathe.

24. The device according to claim 18,
characterised by
a device for controlling the positioning of the underfloor wheelset lathes and/or the rail supports.

25. A method for machining, in particular for simultaneously machining multiple wheelsets of a rail vehicle, comprising the following steps:
a) Provision of:
a first underfloor wheelset lathe for reprofiling wheels and brake discs from a first wheelset of a rail vehicle, and
a second underfloor wheelset lathe for reprofiling wheels and brake discs from a second wheelset of a rail vehicle,
b) Provision of at least two wheelsets to be machined of a rail vehicle,
c) Adjusting the distance between the second underfloor wheelset lathe and the first underfloor wheelset lathe,
d) Setting down and clamping of at least two wheelsets to be machined on the underfloor wheelset lathes assigned to them, and
e) Machining at least two wheelsets to be machined of the rail vehicle on the underfloor wheelset lathes assigned to them, wherein
a third underfloor wheelset lathe for reprofiling wheels and brake discs of a third wheelset of a rail vehicle and a fourth underfloor wheelset lathe for reprofiling wheels and brake discs of a fourth wheelset of a rail vehicle are additionally provided in step a),
four wheelsets to be machined of a rail vehicle are provided in step b),
in step c), the distance between the third underfloor wheelset lathe and the first underfloor wheelset lathe is adjusted and the distance between the fourth underfloor wheelset lathe and the first underfloor wheelset lathe is adjusted,
in step d), four wheelsets to be machined are set down and clamped on the underfloor wheelset lathes assigned to them,
in step e), the third wheelset and/or the fourth wheelset of the rail vehicle is additionally machined on the underfloor wheelset lathes associated therewith, and
wherein in step a), a second rail support is provided between the third underfloor wheelset lathe and the fourth underfloor wheelset lathe,
characterized in that
the step c) comprises the following substeps:
ca) determining the type of rail vehicle with the wheelsets to be machined, and
cb) Setting stored, vehicle-specific distances between the second underfloor wheelset lathe and the first underfloor wheelset lathe,
and that the second rail support is displaceable relative to the third underfloor wheelset lathe and/or relative to the fourth underfloor wheelset lathe.

26. The method according to claim 25,
characterised in that
in step a) an underfloor wheelset lathe is provided.

27. The method according to claim 25,
characterised in that
the step c) comprises the following substep:
cb) Setting stored, vehicle-specific distances between the second and third and/or fourth underfloor wheelset lathes and the first underfloor wheelset lathe.

28. The method according to claim 27,
characterised by
the following step carried out after step ca) and before, simultaneously with or after step cb):
cc) Setting a stored, vehicle-specific position of at least one rail bridge.

29. The method according to claim 25,
characterised in that
step d) comprises the following partial steps:
da) Setting down and clamping the first wheelset to be machined on the underfloor wheelset lathe assigned to it,
db) Measuring the actual distances between the wheelsets to be machined on the rail vehicle,
dc) Adapting the preset distances between the second and/or third and/or fourth underfloor wheelset lathes and the first underfloor wheelset lathe to the actually measured distances between the wheelsets to be machined of the rail vehicle, and
dd) Setting down and clamping the second, third and fourth wheelset to be machined on the underfloor wheelset lathes assigned to them.

30. The method according to claim 25,
characterised by
the following step performed prior to step d):
cz) Retracting the slide rails.
